(19) United States
(12) Patent Application Publication
(10) Pub. No.: US 2007/0153651 A1
(43) Pub. Date: Jul. 5, 2007

(54) OPTICAL STORAGE APPARATUS WITH DYNAMIC ROTATIONAL SPEED CONTROL BY MONITORING STORAGE STATUS OF BUFFER MEMORY AND RELATED METHOD THEREOF

(76) Inventors: Cheng-Chieh Lin, Hsin-Chu City (TW); Yen-Cheng Lin, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 11/306,634

(22) Filed: Jan. 5, 2006

(51) Int. Cl. G11B 20/10

(52) U.S. Cl. 369/47.32; 369/53.31

(57) ABSTRACT

An optical storage apparatus for reproducing data from an optical medium is disclosed. The optical storage apparatus includes a rotation unit for rotating the optical medium at a rotational speed; a buffer memory for buffering data to be transmitted to a host; a data accessing unit, coupled to the buffer memory, for accessing data on the optical medium and storing data read from the optical medium into the buffer memory; and a buffer control block, coupled to the buffer memory, for monitoring a storage status of the buffer memory to control the rotation unit to adjust the rotational speed of the optical medium.

### BACKGROUND

This disclosure relates to an apparatus and method for reproducing data from an optical medium, and more particularly, to an apparatus and method for reproducing data from an optical medium driven at a variable rotational speed.

Optical technology has given rise to highly popular devices such as CD and DVD players. The superior quality of such devices as compared to traditional audio devices has encouraged great development in the field.

Most modern optical disc players utilize a specific rotational speed for both playback and data copying. If this specific rotational speed is relatively low, time taken for data copying will be significant. On the other hand, if the specific rotational speed is relatively high, power will be unnecessarily wasted, and noise due to excess spindle rotation may be present for playback. How to properly set the rotational speed for optimizing both playback and data copying performance becomes an important issue for designers.

### SUMMARY

It is therefore one of the objectives of the present invention to provide an optical disc player that can adjust the rotational speed by monitoring storage status of a buffer memory.

Briefly described, the present disclosure comprises an optical disc rotating at a rotational speed; a rotation unit for rotating the optical disc, the rotation unit comprising a motor, and a rotation block; a data accessing unit for accessing data on the optical disc, the data accessing unit comprising an optical pickup, a servo control block, and a demodulator block; a buffer memory for buffering data accessed from the optical disc; and a buffer control block for determining control parameters of the optical disc system, comparing the control parameters with predetermined thresholds to generate comparison results, and utilizing the comparison results to control the rotational speed of the optical disc.

A first embodiment of the optical storage apparatus determines a first control parameter when a buffer full event occurs; decreases the rotational speed of the disc if the first control parameter is greater than a first predetermined threshold; then determines a second control parameter; and increases the rotational speed of the disc if the second control parameter is greater than the second predetermined threshold. If no buffer full event occurs during a read request, the buffer control block determines the second control parameter and compares it with the second predetermined threshold without first carrying out the first control parameter comparison. The buffer control block will then increase the rotational speed of the disc if the second control parameter is greater than the second predetermined threshold.

A second embodiment of the optical storage apparatus improves on the first embodiment by setting a cache_hit flag if data requested is already in the buffer. The optical storage apparatus resets the second control parameter if the first control parameter is equal to the first predetermined threshold and the cache_hit flag is set, or if the first control parameter is greater than the first predetermined threshold.

A third embodiment calculates a control parameter between two buffer full events, increases the rotational speed if the control parameter is greater than a first predetermined threshold, and decreases the rotational speed if the control parameter is lower than a second predetermined threshold.

A fourth embodiment determines a control parameter between an initial monitor time and a time threshold, decreases the rotational speed if the control parameter is greater than a first predetermined threshold, and increases the rotational speed if the control parameter is lower than a second predetermined threshold.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an optical storage apparatus according to an embodiment of the present invention.

FIG. 2 is a flowchart illustrating a first embodiment of tuning the rotational speed of an optical disc shown in FIG. 1.

FIG. 3 is a flowchart illustrating a second embodiment of tuning the rotational speed of the optical disc shown in FIG. 1.

FIG. 4 is a flowchart illustrating a third embodiment of tuning the rotational speed of the optical disc shown in FIG. 1.

FIG. 5 is a flowchart illustrating a fourth embodiment of tuning the rotational speed of the optical disc shown in FIG. 1.

### DETAILED DESCRIPTION

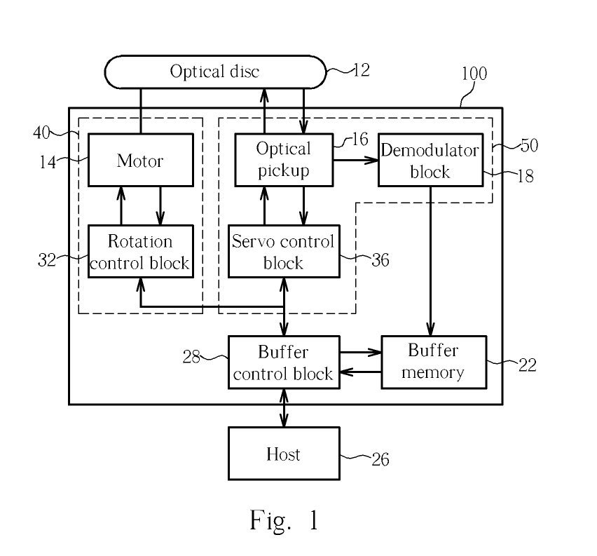

Please refer to FIG. 1. FIG. 1 is a block diagram of an optical storage apparatus 100 according to an embodiment of the present invention. In this embodiment, the optical storage apparatus 100 is an optical disc drive, and is utilized to access an optical disc 12. The optical storage apparatus 100 rotates the optical disc 12 at a variable rotational speed by a rotation unit 40. The rotation unit 40 comprises a motor 14, and a rotation control block 32 used to drive the motor 14 for adjusting the rotational speed of the optical disc 12. When data is requested from the optical disc 12 by a host 26, a data accessing unit 50 accesses data from the optical disc 12, demodulates it and sends it to a buffer memory 22. The data accessing unit 50 comprises an optical pickup 16 for emitting laser light to the optical disc 12 and detecting reflected laser light from the optical disc 12, a servo control block 36 for controlling tracking and focusing of the optical pickup 16, and a demodulator block 18 for demodulating the reflected laser light to obtain the desired data stored on the optical disc 12. A buffer control block 28, connected to the buffer memory 22, is utilized for controlling the rotation unit 40 to drive the optical disc 12 at a particular rotational speed. This is achieved by determining various control parameters of the optical storage apparatus 100, and comparing the control parameters with predetermined thresholds, which is further detailed as follows.

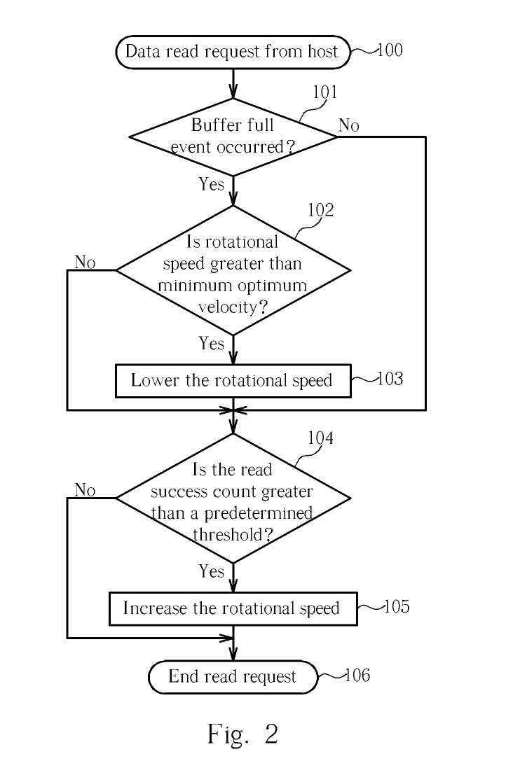

Based on a generated comparison result, the buffer control block 28 will determine whether to control the rotation unit 40 to increase or decrease the rotational speed of the optical disc 12. The control parameters are calculated when it is determined by the buffer control block 28 that the buffer memory 22 is full. Please refer to FIG. 2. FIG. 2 is a flowchart illustrating a first embodiment of tuning the rotational speed of the optical disc 12 shown in FIG. 1. The steps are as follows:

Step 100: Data read request from host 26.

Step 101: Buffer full event occurred? If yes, go to step 102; otherwise, go to step 104.

Step 102: Is rotational speed greater than minimum optimum velocity? If yes, go to step 103; otherwise, go to step 104.

Step 103: Lower the rotational speed.

Step 104: Is the read success count greater than a predetermined threshold? If yes, go to step 105; otherwise, go to step 106.

Step 105: Increase the rotational speed.

Step 106: End read request.

When data is requested by the host 26, data will be reproduced at a maximum optimum rotational speed, and sent to the buffer memory 22 (step 100). If a buffer full event occurs during a read request, this indicates that the rotational speed of the optical disc 12 is too fast (step 101). The buffer control block 28 utilizes the buffer full event to compare the rotational speed of the optical disc 12 with a minimum optimum rotational speed (step 102). If the rotational speed of the optical disc 12 is greater than this threshold (i.e. the minimum optimum rotational speed), the buffer control block 28 will control the rotation control block 32 to decrease the rotational speed of the optical disc 12. This may cause the rotational speed to be lowered too much, so the buffer control block 28 then determines a read success count, i.e. the number of times data is successfully transferred from the buffer memory 22 to the host 26, and compares this to a predetermined threshold (step 104). If the read success count is greater than the predetermined threshold, this indicates that the rotational speed of the optical disc 12 is too slow, so the buffer control block 28 controls the rotation control block 32 to increase the rotational speed of the optical disc 12 (step 105). Please note that, referring to the flowchart shown in FIG. 2, the operation of comparing the read success count with the predetermined threshold takes place even when a buffer full event does not occur in a read request. A DVDROM, for example, has a minimum optimum rotational speed of 4×, and a maximum optimum rotational speed of 16×. If a buffer full event occurs, the rotational speed will be downgraded in increments of 4×: i.e. 16×->12×->8×->4×. The read success count of the DVDROM is set as 10; if data is successfully transferred from the buffer memory to the host ten times, the rotational speed will be increased. Please note these numbers are given as examples to further illustrate the present invention and should not be construed as limitations.

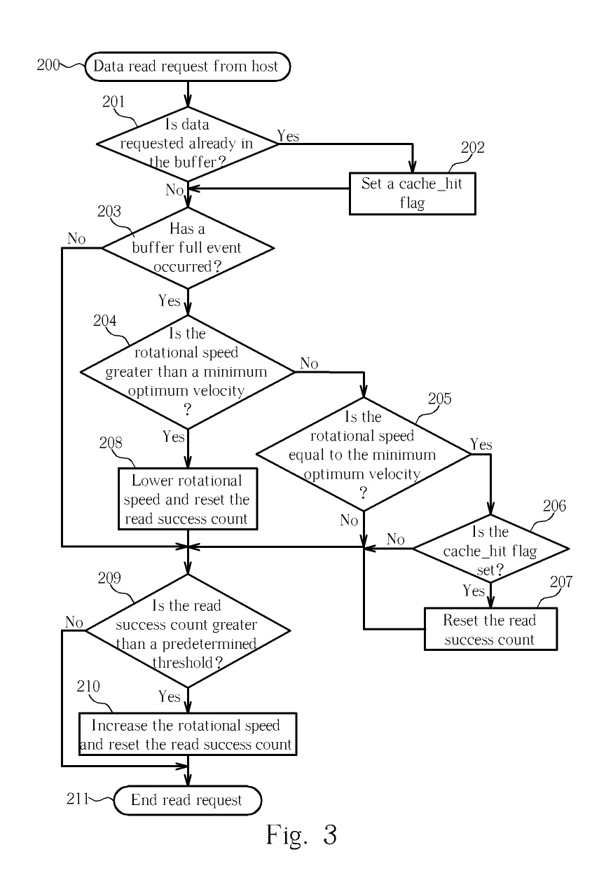

In this first embodiment of the present invention the read success count may exceed the predetermined threshold immediately after a buffer full event occurs. In this case, the optical storage apparatus 100 will switch between a high and a low velocity too fast, degrading the performance of the optical storage apparatus 100. Please refer to FIG. 3. FIG. 3 is a flowchart illustrating a second embodiment of tuning the rotational speed of the optical disc 12 shown in FIG. 1. The steps are as follows:

Step 200: Data read request from host 26.

Step 201: Is data requested already in the buffer memory 22? If yes, go to step 202; otherwise, go to step 203.

Step 202: Set a cache_hit flag.

Step 203: Has a buffer full event occurred? If yes, go to step 204; otherwise, go to step 209.

Step 204: Is the rotational speed greater than a minimum optimum velocity? If yes, go to step 208; otherwise, go to step 205.

Step 205: Is the rotational speed equal to the minimum optimum velocity? If yes, go to step 206; otherwise, go to step 209.

Step 206: Is the cache_hit flag set? If yes, go to step 207; otherwise, go to step 209;

Step 207: Reset the read success count. Go to step 209.

Step 208: Lower rotational speed and reset the read success count.

Step 209: Is the read success count greater than a predetermined threshold? If yes, go to step 210; otherwise, go to step 211.

Step 210: Increase the rotational speed and reset the read success count.

Step 211: End read request.

The second embodiment is similar to the first embodiment but is able to prevent the premature switching between high and low rotational velocities, by resetting the read success count after the rotational speed is decreased, and by utilizing a cache_hit flag for resetting the read success count. When data requested is already stored in the buffer memory 22 after the host 26 issues the corresponding data request, a cache_hit flag is set (steps 200, 201, and 202). When the cache_hit flag is set, the read success count should be reset to zero to avoid the velocity being raised. If the rotational speed is equal to the minimum optimum rotational speed and the cache_hit flag is set, the read success count is reset (steps 205, 206, and 207). If the rotational speed is greater than the minimum optimum rotational speed, the rotational speed is lowered and the read success count is reset (steps 204 and 208). The read success count is then compared with the predetermined threshold, as in the previous embodiment, and the rotational speed increased if the read success count is greater than the threshold (steps 209 and 210). Since part of the steps shown in FIG. 3 are identical to that shown in FIG. 2, further description is omitted here for brevity.

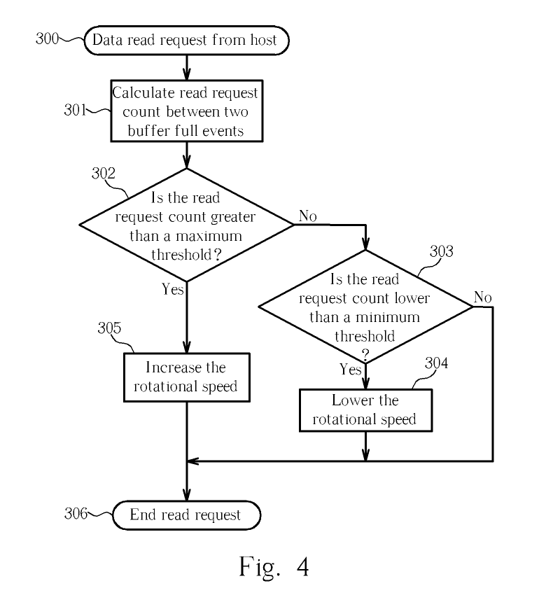

Please refer to FIG. 4. FIG. 4 is a flowchart illustrating a third embodiment of tuning the rotational speed of the optical disc 12 shown in FIG. 1. The steps are as follows:

Step 300: Data read request from host 26.

Step 301: Calculate read request count between two buffer full events.

Step 302: Is the read request count greater than a maximum threshold? If yes, go to step 305; otherwise, go to step 303.

Step 303: Is the read request count lower than a minimum threshold? If yes, go to step 304; otherwise, go to step 306.

Step 304: Lower the rotational speed. Go to step 306.

Step 305: Increase the rotational speed.

Step 306: End read request.

In this embodiment, after the host 26 issues a data request to the optical storage apparatus 100, the buffer control block 28 determines the read request count between two buffer full events (steps 300 and 301). Then, the buffer control block 28 is designed to have two predetermined thresholds, i.e. a maximum threshold and a minimum threshold, used to examine the calculated read request count. If the frequency of read requests from the host 26 between two buffer full events (i.e. the calculated read request count) is greater than the maximum threshold, this indicates that the rotational speed of the optical disc 12 is too low, so the buffer control block 28 controls the rotation control block 32 to increase the rotational speed of the optical disc 12 (steps 302 and 305). However, if the read request count is not greater than the maximum threshold, the read request count will be compared with the minimum threshold (steps 302 and 303). If the frequency of read requests from the host 26 between two buffer full events is lower than the minimum threshold, this indicates that the rotational speed of the optical disc 12 is too high, so the buffer control block 28 controls the rotation control block 28 to decrease the rotational speed of the optical disc 12 (steps 303 and 304).

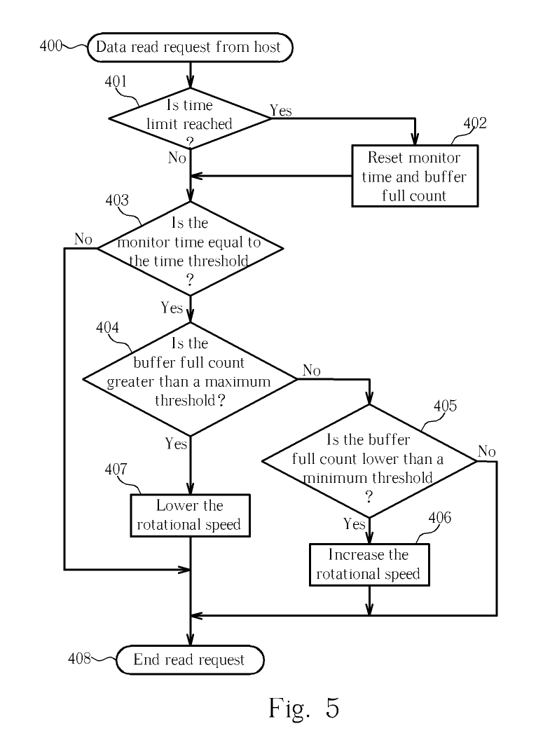

Please refer to FIG. 5. FIG. 5 is a flowchart illustrating a fourth embodiment of tuning the rotational speed of the optical disc 12 shown in FIG. 1. The steps are as follows:

Step 400: Data read request from host 26.

Step 401: Is time limit reached? If yes, go to step 402; otherwise, go to step 403.

Step 402: Reset monitor time and buffer full count. Go to step 403.

Step 403: Is the monitor time equal to the time threshold? If yes, go to step 404; otherwise, go to step 408.

Step 404: Is the buffer full count greater than a maximum threshold? If yes, go to step 407; otherwise, go to step 405.

Step 405: Is the buffer full count lower than a minimum threshold? If yes, go to step 406; otherwise, go to step 408.

Step 406: Increase the rotational speed. Go to step 408.

Step 407: Lower the rotational speed.

Step 408: End read request.

The buffer control block 28 determines the number of buffer full events between an initial monitor time and a time threshold. In this embodiment, after the host 26 issues a data request, the buffer control block 28 checks if the preset time limit is reached (steps 400 and 401). Please note that the time limit is greater than the time threshold. In this embodiment, using the preset time limit is to define the resetting timing for the increasing monitor time and the buffer full count. That is, each time the monitor time reaches the time limit, the monitor time is reset to the initial monitor time and the calculated buffer full count is reset to an initial value (e.g. zero) (step 402). Then, when the monitor time reaches the time threshold, the buffer control block 28 checks the currently calculated buffer full count (steps 403 and 404). If the buffer full count is greater than a maximum threshold, this indicates that the rotational speed is too high, as the buffer memory 22 is being filled with data too quickly. Therefore, the buffer control block 28 will decrease the rotational speed of the optical disc 12 by controlling the rotation control block 32. However, if the buffer full count is lower than the maximum threshold, it will be compared with a minimum threshold (step 405). If the buffer full count is lower than the minimum threshold, this indicates that the rotational speed is too low, so the buffer control block 28 will increase the rotational speed of the optical disc 12 by controlling the rotation control block 32 (step 406). It should be noted that the clock continues to monitor the time over repeated read requests. Therefore, once the time limit is reached, the monitor time and the buffer full count are reset.

Please note that the maximum threshold (in step 404) and the minimum threshold could be preset according to the rotational speed. For example, when the rotational speed is 16×, the maximum threshold is set to 24 and the minimum threshold is set to 12. When the rotational speed is 12×, the maximum threshold is set to 22 and the minimum speed is set to 14. When the rotational speed is 8×, the maximum threshold is set to 20 and the minimum threshold is set to 16. Please note that these thresholds are merely given as examples and should not be taken as limitations of the present invention.

Referring to the above embodiments, the buffer control block for monitoring buffer full events and comparing counts with predetermined thresholds to lower or raise the rotational speed allows maximum efficiency to be reached during data recording operation and prevents noise caused by excess spindle rotation during playback operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical storage apparatus for reproducing data from an optical medium, the optical storage apparatus comprising:
a rotation unit for rotating the optical medium at a rotational speed;
a buffer memory for buffering data to be transmitted to a host;
a data accessing unit, coupled to the buffer memory, for accessing data on the optical medium and storing data read from the optical medium into the buffer memory; and
a buffer control block, coupled to the buffer memory, for monitoring a storage status of the buffer memory to control the rotation unit to adjust the rotational speed of the optical medium.

2. The optical storage apparatus of claim 1, wherein the buffer control block monitors the storage status to determine at least a control parameter, compares the control parameter with at least a predetermined threshold to generate a comparison result, and then controls the rotation unit to adjust the rotational speed of the optical medium according to the comparison result.

3. The optical storage apparatus of claim 2, wherein the buffer control block determines the control parameter by counting the number of times requested data is successfully transferred to the host.

4. The optical storage apparatus of claim 3, wherein when the control parameter is greater than the predetermined threshold, the buffer control block controls the rotation unit to increase the rotational speed of the optical medium.

5. The optical storage apparatus of claim 2, wherein the buffer control block determines a first control parameter when the buffer memory is full, and the first control parameter is the current rotational speed of the optical medium.

6. The optical storage apparatus of claim 5, wherein when the first control parameter is greater than a first predetermined threshold, the buffer control block controls the rotation unit to decrease the rotational speed of the optical medium.

7. The optical storage apparatus of claim 6, wherein when the buffer is not full, the buffer is full but the first control parameter is not greater than a first predetermined threshold, or after the buffer control block controls the rotation unit to decrease the rotational speed of the optical medium, the buffer control block determines a second control parameter by counting the number of times requested data is transferred to the host.

8. The optical storage apparatus of claim 7, wherein when the second control parameter is greater than a second predetermined threshold, the buffer control block controls the rotation unit to increase the rotational speed of the optical medium.

9. The optical storage apparatus of claim 7, wherein when the first control parameter is greater than the first predetermined threshold, the buffer control block further resets the second control parameter.

10. The optical storage apparatus of claim 7, wherein when the first control parameter is equal to the first predetermined threshold and the requested data has been cached in the buffer memory, the buffer control block resets the second control parameter.

11. The optical storage apparatus of claim 2, wherein the buffer control block determines the control parameter by counting the number of read requests between two successive buffer memory full events.

12. The optical storage apparatus of claim 11, wherein when the control parameter is greater than a first predetermined threshold, the buffer control block controls the rotation unit to increase the rotational speed of the optical medium, and when the control parameter is less than a second predetermined threshold, the buffer control block controls the rotation unit to decrease the rotational speed of the optical medium.

13. The optical storage apparatus of claim 2, wherein the buffer control block determines the control parameter by counting the number of buffer memory full events between an initial monitor time and a time threshold.

14. The optical storage apparatus of claim 13, wherein when the control parameter is greater than a first predetermined threshold, the buffer control block controls the rotation unit to decrease the rotational speed of the optical medium, and when the control parameter is less than a second predetermined threshold, the buffer control block controls the rotation unit to increase the rotational speed of the optical medium.

15. The optical storage apparatus of claim 13, wherein the buffer control block resets the control parameter and the monitor time for re-counting the number of buffer memory full events once the monitor time reaches a monitor time limit.

16. A method for reproducing data from an optical medium via a buffer memory for buffering data to be transmitted to a host, the method comprising:
rotating the optical medium at a rotational speed;
accessing data on the optical medium and storing data read from the optical medium into the buffer memory; and
monitoring a storage status of the buffer memory to adjust the rotational speed of the optical medium.

17. The method of claim 16, wherein the step of monitoring the storage status of the buffer memory to adjust the rotational speed of the optical medium further comprises:
monitoring the storage status to determine at least a control parameter;
comparing the control parameter with a predetermined threshold to generate a comparison result; and
adjusting the rotational speed of the optical medium according to the comparison result.

18. The method of claim 17, wherein the step of determining the control parameter is performed by counting the number of times requested data is successfully transferred to the host.

19. The method of claim 18, wherein the step of adjusting the rotational speed of the optical medium according to the comparison result further comprises:
when the control parameter is greater than the predetermined threshold, increasing the rotational speed of the optical medium.

20. The method of claim 17, wherein the step of determining the control parameter is performed by determining a first control parameter when the buffer is full, wherein the first control parameter is the current rotational speed of the optical medium rotational speed.

21. The method of claim 20 wherein the step of adjusting the rotational speed of the optical medium according to the comparison result further comprises:
when the first control parameter is greater than a first predetermined threshold, decreasing the rotational speed of the optical medium.

22. The method of claim 21, wherein the step of determining the control parameter further comprises:
when the buffer is not full, the buffer is full but the first control parameter is not greater than a first predetermined threshold, or after decreasing the rotational speed, determining a second control parameter by counting the number of times requested data is successfully transferred to the host.

23. The method of claim 22, wherein the step of adjusting the rotational speed of the optical medium according to the comparison result further comprises:
when the second control parameter is greater than the second predetermined threshold, increasing the rotational speed of the optical medium.

24. The method of claim 22, further comprising:
when the first control parameter is greater than the first predetermined threshold, resetting the second control parameter.

25. The method of claim 22, further comprising:
when the first control parameter is equal to the first predetermined threshold, and requested data has been cached in the buffer memory, resetting the second control parameter.

26. The method of claim 17, wherein the step of determining the control parameter is performed by counting the number of read requests between two buffer full events.

27. The method of claim 26, wherein the step of adjusting the rotational speed of the optical medium according to the comparison result further comprises:
increasing the rotational speed of the optical medium when the control parameter is greater than a first predetermined threshold; and
decreasing the rotational speed of the optical medium when the control parameter is less than a second predetermined threshold.

28. The method of claim 17, wherein the step of determining the control parameter is performed by counting the number of buffer full events between an initial monitor time and a time threshold.

29. The method of claim 28, wherein the step of adjusting the rotational speed of the optical medium according to the comparison result further comprises:
decreasing the rotational speed of the optical medium when the control parameter is greater than a first predetermined threshold; and
increasing the rotational speed of the optical medium when the control parameter is less than a second predetermined threshold.

30. The method of claim 28, further comprising:
resetting the monitor time after a predetermined time limit.
